(19) United States
(12) Patent Application Publication
(10) Pub. No.: US 2024/0124749 A1
(43) Pub. Date: Apr. 18, 2024

(54) Adhesive tape and method for jacketing elongated items, especially leads

(71) Applicant: tesa SE, Norderstedt (DE)

(72) Inventors: Kerstin KLINGEBERG, Uetersen (DE); Olga KIRPICENOK, Ellerbek (DE); Hans-Peter GRAEF, Hamburg (DE); Philipp WEGENER, Buxtenhude (DE); Gerhard BIR, Hamburg (DE)

(73) Assignee: tesa SE, Norderstedt (DE)

(21) Appl. No.: 17/966,220

(22) Filed: Oct. 14, 2022

(51) Int. Cl. C09J 7/38; B32B 5/02; B32B 27/12; C09J 7/24; C09J 7/40

(52) U.S. Cl. CPC C09J 7/38; B32B 5/022; B32B 5/024; B32B 27/12; C09J 7/243; C09J 7/401; B32B 27/32; C09J 2203/302; C09J 2463/00

(57) ABSTRACT

The invention relates to an adhesive tape for jacketing elongated items such as more particularly leads or cable sets, comprising a tapelike carrier provided on at least one side with a curable adhesive, characterized in that the adhesive tape is further provided on one side of the tapelike carrier with a release layer of carbamate.

The invention relates to an adhesive tape for jacketing elongated items such as more particularly leads or cable sets, comprising a tapelike carrier provided on at least one side with a curable adhesive, and to a method for jacketing elongated items, especially cable sets.

Adhesive tapes have been used in industry for producing cable looms for some considerable time. The adhesive tapes are employed for bundling a multiplicity of electrical leads prior to installation or in an already assembled state, in order, for example, to reduce the space taken up by the bundle of leads, by bandaging them, and additionally to achieve protective functions such as protection from mechanical and/or thermal stressing. Common forms of adhesive tapes include film carriers or textile carriers, coated in general on one side with pressure-sensitive adhesives. Adhesive tapes for jacketing elongated items are known from, for example, DE 10 2013 213 726 A1, EP 1 848 006 A2 and EP 2 497 805 A1.

Present cable harnesses swathed with adhesive tape are generally flexible. This flexibility is often undesirable, however, for technical reasons associated with manufacture. In manufacture, the cable harnesses are generally prefabricated to a cable plan and then inserted into the article to be equipped, such as a car, for example. A cable set plan corresponds to the actual three-dimensional disposition of the individual cable harnesses in the cable set, thus showing which cable harness is bent at which angle and at which point, where positions of branches or outbindings are located, and with which connectors the ends of the cable harnesses are fitted.

In order to hold the individual harnesses of the cable set in a defined shape, allowing them to be guided around the engine in the engine compartment, for example, without coming into contact with the engine, it is common to mount injection-moulded components subsequently around the cable loom swathed with adhesive tape. A disadvantage of these injection-moulded components, however, is that they entail additional material and additional assembly work.

The publications DE 10 2019 211 178 A1, DE 10 2019 210 708 A1 or DE 10 2019 206 929 A1 disclose a method for jacketing elongated items such as, more particularly, leads or cable sets, wherein the elongated item is wrapped with an adhesive tape, with curable adhesive applied thereon, in a helical line or in an axial direction, and the adhesive applied on the adhesive tape is activated and cured.

Cable looms for the automotive industry are produced on a standard basis using adhesive tapes which have neither a release paper/liner nor a release layer. Such adhesive tapes must not exceed a certain peel adhesion to their own reverse, since otherwise it would be simply no longer possible, or possible only with great expenditure of force, for the roll of adhesive tape to be unwound. The peel adhesion must therefore not exceed a certain value. A frequent corollary of this, however, on the other hand, is a low peel adhesion to the cable insulation and to other constituents of the cable loom (fluted tubes, shrink-on hoses, plug connections) to which, however, a high peel adhesion is required. A low peel adhesion, indeed, may result in the join between adhesive tape and cable insulation or the aforementioned other constituents failing, with the consequence that the cable loom is subsequently not protected by the adhesive tape. There is also a need for relatively high peel adhesions in applications involving heightened requirements (heightened temperature, vibrational and abrasion loads), in order to guarantee the exact positioning of the adhesive tape, not least over the lifetime of a vehicle.

In order to obtain a cable wrapping tape with increased peel adhesion, but without release paper/liner which is a disruption in use, it is necessary to employ a release layer in order to be able to ensure unwinding of the roll. Accordingly a release layer is applied to the carrier nonwoven impregnated with adhesive, in order to reduce the adhesion of the adhesive tape to itself. Since, however, a cable wrapping tape is applied not only to the cable insulation or other constituents of the cable loom but also, in view of the overlapping wrapping, “to itself” or to its own adhesive tape reverse, the release results in a lowering of the peel adhesion on the reverse of the adhesive tape, and this may lead to a reduction in the bond strength and to the detachment of the plies in the utility.

There is therefore on the one hand the need for sufficiently low peel adhesion between adhesive layer and the reverse of the cable wrapping tape itself, in order to ensure unwindability, while on the other hand the peel adhesion between adhesive layer and the reverse of the cable wrapping tape itself, after application has taken place, must be as great as possible, in order to ensure that the adhesive tape in an overlapping disposition adheres reliably and well to itself. This appears to be an irreconcilable contradiction, since the adhesive cannot “know” when it is supposed to adhere very well and when less well.

It is an object of the present invention, therefore, to provide an adhesive tape for wrapping elongated items that eliminates the disadvantages described above and fulfils the requirements described above, thereby resolving the contradiction, adhering on the one hand to itself to an extent only such that it can still be easily unwound, while on the other hand, following application, adhering so strongly that detachment no longer takes place.

Another object of the present invention is to provide a method for wrapping elongated items and also a product obtainable with the method.

This object is achieved by an adhesive tape as described in the independent claim. The dependent claims provide advantageous developments of the subject matter of the invention. The invention embraces, furthermore, a method for wrapping elongated items with the adhesive tape, and a product obtainable with the method.

The invention relates accordingly to an adhesive tape of the aforementioned kind wherein the adhesive tape is further provided on one side of the tapelike carrier with a release layer, also referred to as a parting layer, of carbamate.

Carbamates are salts and esters of carbamic acids (R₂N—COOH). In solution, carbamates are good release substances for polyolefins and for substrates having a coating of adhesive based on natural rubber, synthetic rubber or acrylate and having a low melting point, such as PE, PP, PVC and PET. Carbamates produced from polyvinyl acetate and stearyl isocyanate have shown themselves to be advantageous. The polyvinylstearyl carbamate is produced by the partial hydrolysis of polyvinyl acetate and subsequent reaction with stearyl isocyanate. For the production of polyvinyl alcohol, the polyvinyl acetate is hydrolysed so that acetate groups are replaced by hydroxyl groups. This conversion, however, is not complete, and so there are still acetate groups present. The reaction with isocyanate leads to a replacement of the hydroxyl groups with carbamate groups, which bind themselves as long side chains to the carbon atoms. The production of carbamates suitable as adhesive tape is indicated in U.S. Pat. No. 2,532,011 A.

The carbamates produced are different, with main chains and side chains of different lengths, depending on the use of esters and/or alcohols and isocyanates, and these differences influence the melting point and crystallinity. Not only the starting materials but also the purity of the polymer and the degree of substitution affect the different melting points of the carbamates and therefore their temperature stability. Where pure isocyanate is used for the reaction, the melting point is higher than if a less pure grade is employed. If the isocyanate contains other fatty acids as impurities, the melting point is lowered.

On supply of heat, carbamates undergo a recrystallization process the effect of which is to break the orientation of the carbamate and so to lower or even deactivate the release effect of the carbamate layer. This activity can be utilized in order to achieve the objective identified above. In this case a carbamate is selected such that the recrystallization process is situated in a temperature range which is sufficiently far removed from the application temperature (use of the adhesive tape) and as close as possible to the temperature of the curing operation. In the region of the curing temperature, the supply of heat breaks the high degree of order brought about by the crystallization of the stearyl side chains, and thereby reduces the release effect. As a result, the adhesive is able to bond to the carrier material beneath the carbamate layer, so increasing the adhesion of the layer of adhesive on the carrier material.

The effect of this is that initially the layer of adhesive adheres on the carrier layer to a sufficiently low extent to allow the adhesive tape to be easily applied from the state in which it is wound up on itself. After application has taken place, the introduction of heat initiates a recrystallization process the result of which is that the release effect of the release layer subsides, thereby increasing the adhesion of the adhesive tape to itself, or more exactly to its own reverse. The bond strength of the plies and the requisite strength in the finished product are therefore ensured.

The release effect of the carbamate is therefore temperature-reversible; it can be deactivated by exposure to heat.

The peel adhesion of the adhesive, increased relative to conventional adhesive tapes, that is required for use as a cable wrapping tape, especially in the automotive industry, can therefore be secured and maintained, while at the same time it is ensured that the adhesive tape has handling qualities in line with the requirements. Accordingly, in particular, application with an applicator in the form of a roll dispenser by simple unwinding is possible, without the user needing to exert excessive force.

The temperature which is needed in order to deactivate the carbamate effect, in other words to start in train the process of recrystallization of the carbamate, is dependent on the type of carbamate used. The temperature is usually in the region of the melting temperature of the carbamate. The higher the temperature selected, the more rapid the process. The matter of which carbamate is preferentially employed is dependent on the particular application. Cable harnesses in the vehicle interior are exposed to maximum temperatures lower than those in the engine compartment. Correspondingly, the cable insulation in the vehicle interior is customarily different from that in the engine compartment. In the vehicle interior, on the basis of the price in particular, the standard material used for the cable jacketing is polyvinyl chloride (PVC). PVC is not particularly heat-stable. The recrystallization temperature and hence the melting temperature must therefore lie within a range which is not critical for the PVC. Customary temperatures to which heating takes place begin at 80° C., and for carbamates which are used on cable wrapping tapes for the interior segment they are preferably in the range from 110° C. to 140° C.

In the engine compartment, cables must be temperature-stable up to 175° C. Customary temperatures in the engine compartment are 150° C. The insulation used here mostly comprises fluorinated hydrocarbons such as ethylene-tetrafluoroethylene copolymers (ETFE). The temperatures used for the recrystallizations may also be higher accordingly. This allows the time needed for the recrystallization and hence for the lowering of the release effect to be reduced.

The construction of the adhesive tape of the invention is preferably such that it is provided on one side of the tapelike carrier with a curable adhesive and on the other side with the release layer of carbamate. The adhesive tape then consists of three layers, in the sequence adhesive-carrier-carbamate layer. This carrier layer may also consist of a plurality of layers. The adhesive is generally applied to a textile or nonwoven fabric. The adhesive penetrates this textile or nonwoven layer and impregnates it. On the side facing away from the adhesive, the textile or nonwoven layer frequently has a film layer, which acts as a barrier layer, so that the adhesive remains on one side of the carrier.

The curable adhesive is activated in particular by means of radiation energy, heat energy, moisture or pressure. Activation by means of heat energy is particularly preferred here. Since introduction of heat is likewise required to change the orientation of the carbamate in order to lower the release effect, the activation of the adhesive with heat energy means that both processes can be initiated at once, these being both the activation of the adhesive and the lowering of the release effect or “deactivation” of the release layer. It may, however, also be advantageous to choose a different form of activation for the adhesive. If, for example, activation is accomplished by means of UV radiation, it is possible additionally to employ an IR lamp in order to introduce the heat needed for lowering the release effect into the system by means of IR radiation.

Carbamates are salts and esters of carbamic acid. Polyurethanes are also classed as carbamates. They are particularly suitable for the present invention, as they have melting points which meet the temperature requirements of the release layer of the invention.

In one particularly preferred embodiment the curable adhesive is pressure-sensitive. In other words, the adhesive used may be a pressure-sensitive adhesive which is curable. This is achievable in particular by admixing the pressure-sensitive adhesive with compounds that are capable of crosslinking, known as crosslinkers. As used herein, the term “crosslinker” stands for chemical compounds which are capable of joining molecular chains to one another, thus allowing the two-dimensional structures to develop, by forming intermolecular bridges, into three-dimensionally crosslinked structures. Crosslinkers are those compounds—especially di- or polyfunctional, usually of low molecular mass—that under the chosen crosslinking conditions are able to react with suitable—especially functional—groups in the polymers to be crosslinked, and so link two or more polymers or polymer sites to one another (form “bridges”) and hence create a network of the polymer or polymers to be crosslinked. This generally results in an increase in cohesion. Typical examples of crosslinkers are chemical compounds which, within the molecule or at the two ends of the molecule, have two or more identical or different functional groups and, consequently, are able to crosslink molecules with the same or else different structures with one another. A crosslinker, moreover, is able to react with the reactive monomer or reactive resin without an accompanying polymerization in the true sense.

In accordance with the invention, the curable adhesive used is a structural adhesive (construction adhesive, assembly adhesive) (see Rompp, Georg Thieme Verlag, document coding RD-19-04489, last update: September 2012). According to DIN EN 923: 2006-01, structural adhesives are adhesives forming bonds capable of sustaining in a structure a specified strength for a defined longer period of time (according to the ASTM definition: “bonding agents used for transferring required loads between adherends exposed to service environments typical for the structure involved). They are therefore adhesives for bonds which are highly robust both chemically and physically, and in the cured state they contribute to strengthening the bonded substrates and are used for producing structures made from metals, ceramic, concrete, wood or reinforced plastics. The structural adhesives of the invention are based more particularly on reactive adhesives (phenolic resins, epoxy resins, polyimides, polyurethanes and others).

In order to solve the technical problems, one preferred embodiment of the invention proposes an adhesive tape for wrapping elongate items, comprising a tapelike carrier provided on at least one side with an adhesive layer, where the adhesive layer comprises a UV-curable composition comprising, based on the total weight of the composition:

| | |
|---|---|
| 15 to 50 wt % | matrix |
| 49.9 to 82 wt % | epoxy resin |
| 0.1 to 3 wt % | photoinitiator |

where the matrix polymer forms a self-supporting film in which epoxy resin and photoinitiator are embedded.

In the simplest variant the adhesive layer in the adhesive tape of the invention is a monolayer of the UV-curable composition.

Another variant provides for a multilayer construction of the adhesive layer. Besides the layer of the UV-curable composition there is a further layer of a pressure-sensitive adhesive, preferably lying on the outside.

In a further variant the adhesive layer comprises a mixture of the UV-curable composition and a self-adhesive pressure-sensitive adhesive.

The matrix polymer is preferably selected from the group consisting of styrene copolymers, acrylate copolymers, methacrylate copolymers, thermoplastic polyurethanes, copolyesters, copolyamides and ethylene-vinyl acetate copolymers and mixtures thereof.

As epoxy resin(s) of the UV-curable composition it is possible to use a single epoxy resin or a mixture of epoxy resins. In principle it is possible to use epoxy resins which are liquid at room temperature or epoxy resins which are solid at room temperature, or mixtures thereof.

Examples, without wishing to impose any limitation, are 3,4-epoxycyclohexylmethyl 3′,4′-epoxycyclohexanecarboxylate (EEC) and derivatives, dicyclopentadiene dioxide and derivatives, 3-ethyl-3-oxetanemethanol and derivatives, diglycidyl tetrahydrophthalate and derivatives, diglycidyl hexahydrophthalate and derivatives, ethane 1,2-diglycidyl ether and derivatives, propane 1,3-diglycidyl ether and derivatives, 1,4-butanediol diglycidyl ether and derivatives, higher alkane 1,n-diglycidyl ethers and derivatives, bis[(3,4-epoxycyclohexyl)methyl] adipate and derivatives, vinylcyclohexyl dioxide and derivatives, 1,4-cyclohexanedimethanol bis(3,4-epoxycyclohexanecarboxylate) and derivatives, diglycidyl 4,5-epoxytetrahydrophthalate and derivatives, bis[1-ethyl(3-oxetanyl)methyl] ether and derivatives, pentaerythritol tetraglycidyl ether and derivatives, bisphenol A diglycidyl ether (DGEBA), hydrogenated bisphenol A diglycidyl ether, bisphenol F diglycidyl ether, hydrogenated bisphenol F diglycidyl ether, epoxyphenol novolacs, hydrogenated epoxyphenol novolacs, epoxycresol novolacs, hydrogenated epoxycresol novolacs, 2-(7-oxabicyclo[4.1.0]hept-3-yl)spiro[1,3-dioxane-5,3′-[7]oxabicyclo[4.1.0]heptane], 1,4-bis((2,3-epoxypropoxy)methyl)cyclohexane.

Reactive resins may be used in their monomeric form or else in their dimeric, trimeric, and so on up to their oligomeric form.

The epoxy resin or at least one of the epoxy resins is preferably a solid, more particularly a solid having a softening temperature of at least 45° C. or a solid having a viscosity at 25° C. of at least 20 Pa*s, more preferably at least 50 Pa*s, more particularly at least 150 Pa*s (determined according to DIN 53019-1 at 25° C. and a shear rate of 1 s⁻¹).

In one preferred embodiment of the adhesive tape of the invention, the epoxy resins comprise a mixture of epoxy resins liquid at 25° C. and epoxy resins solid at 25° C. The fraction of the liquid epoxy resins among the epoxy resins (E) is more particularly 10 to 90 wt %, more preferably 20 to 75 wt %. The respective difference to 100 wt % of the epoxy resins is then made up of solid epoxy resins. Adhesive tapes with ratios of this kind between liquid and solid epoxy components exhibit particularly balanced adhesive properties in the uncured state. Where an adhesive tape having particularly good flow—on properties is desired, the fraction of liquid epoxy components is preferably 50 to 80 wt %. For applications in which the adhesive tapes are required to carry a relatively high load even in the uncured state, a fraction of 15 to 45 wt % is particularly preferred. It is possible to use one such resin or else a mixture of different resins.

With further preference the epoxy resins comprise at least two different epoxy resins (E-1) and (E-2), of which
a) the first epoxy resin (E-1) at 25° C. has a dynamic viscosity of less than 500 Pa·s, measured according to DIN 53019-1 at a measuring temperature of 25° C. and a shear rate of 1 s⁻¹, and
b) the second epoxy resin (E-2) has a softening temperature of at least 45° C. or at 25° C. a dynamic viscosity of at least 1000 Pa·s, measured according to DIN 53019-1 at a measuring temperature of 25° C. and a shear rate of 1 s⁻¹,
   where in particular the fraction of the first epoxy resin (E-1) is 10 to 90 wt %, preferably 20 to 75 wt %, and the fraction of the second epoxy resin (E-2) is 10 to 90 wt %, preferably 25 to 80 wt %, based on the entirety of epoxy resins. The epoxy resin component advantageously consists of these two epoxy resins (E-1) and (E-2), and accordingly the fractions of the two epoxy resins (E-1) and (E-2) as a proportion of the total epoxy resin add up to 100 wt/0.

Particularly good pressure-sensitive adhesives are obtained if the fraction of epoxy resin (E2) is in the range from 40 to 80 wt %, more particularly 60 to 75 wt %. In one specific embodiment the fraction of epoxy resins (E-2) having a softening temperature of at least 45° C. is at least 35 wt %, more particularly in the 40 to 70 wt % range.

The cohesion of the non-crosslinked pressure-sensitive adhesives is particularly good, while still maintaining sufficient pressure-sensitive tack, if the fraction of epoxy resins having a softening temperature of at least 45° C. is at least 15 wt %, being situated more particularly in the range from 20 wt % to 75 wt %, based on the total epoxy resin. The flow-on characteristics are improved if there is less than 55 wt %, more particularly between 25 wt % and 45 wt %.

The adhesive formulation further comprises at least one kind of a photoinitiator for the cationic curing of the reactive resins. Among the initiators for cationic UV curing it is possible more particularly to use sulfonium, iodonium and metallocene based systems.

As examples of sulfonium based cations, reference may be made to the statements in U.S. Pat. No. 6,908,722 B1 (especially columns 10 to 21).

As examples of anions which serve as counterions for the above-stated cations, reference may be made to tetrafluoroborate, tetraphenylborate, hexafluorophosphate, perchlorate, tetrachloroferrate, hexafluoroarsenate, hexafluoroantimonate, pentafluorohydroxy-antimonate, hexachloroantimonate, tetrakispentafluorophenylborate, tetrakis(pentafluoro-methylphenyl) borate, bis(trifluoromethylsulfonyl)amide and tris(trifluoromethylsulfonyl)-methide. Especially for iodonium-based initiators, furthermore, consideration may also be given to chloride, bromide or iodide as anions, although initiators substantially free from chlorine and bromine are preferred.

By way of example, the systems which can be used include
sulfonium salts (see, for example, U.S. Pat. Nos. 4,231,951 A, 4,256,828 A, 4,058,401 A, 4,138,255 A and US 2010/063221 A1) such as
triphenylsulfonium hexafluoroarsenate,
triphenylsulfonium hexafluoroborate,
triphenylsulfonium tetrafluoroborate,
triphenylsulfonium tetrakis(pentafluorobenzyl)borate,
methyldiphenylsulfonium tetrafluoroborate,
methyldiphenylsulfonium tetrakis(pentafluorobenzyl)borate,
dimethylphenylsulfonium hexafluorophosphate,
triphenylsulfonium hexafluorophosphate,
triphenylsulfonium hexafluoroantimonate,
diphenylnaphthylsulfonium hexafluoroarsenate,
tritolylsulfonium hexafluorophosphate,
anisyldiphenylsulfonium hexafluoroantimonate,
4-butoxyphenyldiphenylsulfonium tetrafluoroborate,
4-butoxyphenyldiphenylsulfonium tetrakis(pentafluorobenzyl)borate,
4-chlorophenyldiphenylsulfonium hexafluoroantimonate,
tris(4-phenoxyphenyl)sulfonium hexafluorophosphate,
di(4-ethoxyphenyl)methylsulfonium hexafluoroarsenate,
4-acetylphenyldiphenylsulfonium tetrafluoroborate,
4-acetylphenyldiphenylsulfonium tetrakis(pentafluorobenzyl)borate,
tris(4-thiomethoxyphenyl)sulfonium hexafluorophosphate,
di(methoxysulfonylphenyl)methylsulfonium hexafluoroantimonate,
di(methoxynaphthyl)methylsulfonium tetrafluoroborate,
di(methoxynaphthyl)methylsulfonium tetrakis(pentafluorobenzyl)borate,
di(carbomethoxyphenyl)methylsulfonium hexafluorophosphate,
(4-octyloxyphenyl)diphenylsulfonium tetrakis(3,5-bistrifluoromethylphenyl)borate,
tris[4-(4-acetylphenyl)thiophenyl]sulfonium tetrakis(pentafluorophenyl)borate,
tris(dodecylphenyl)sulfonium tetrakis(3,5-bistrifluoromethylphenyl)borate,
4-acetamidophenyldiphenylsulfonium tetrafluoroborate,
4-acetamidophenyldiphenylsulfonium tetrakis(pentafluorobenzyl)borate,
dimethylnaphthylsulfonium hexafluorophosphate,
trifluoromethyldiphenylsulfonium tetrafluoroborate,
trifluoromethyldiphenylsulfonium tetrakis(pentafluorobenzyl)borate,
phenylmethylbenzylsulfonium hexafluorophosphate,
5-methylthianthrenium hexafluorophosphate,
10-phenyl-9,9-dimethylthioxanthenium hexafluorophosphate,
10-phenyl-9-oxothioxanthenium tetrafluoroborate,
10-phenyl-9-oxothioxanthenium tetrakis(pentafluorobenzyl)borate,
5-methyl-10-oxothianthrenium tetrafluoroborate,
5-methyl-10-oxothianthrenium tetrakis(pentafluorobenzyl)borate and
5-methyl-10,10-dioxothianthrenium hexafluorophosphate,
iodonium salts (see, for example, U.S. Pat. Nos. 3,729,313 A, 3,741,769 A, 4,250,053 A, 4,394,403 A and US 2010/063221 A1) such as
diphenyliodonium tetrafluoroborate,
di(4-methylphenyl)iodonium tetrafluoroborate,
phenyl-4-methylphenyliodonium tetrafluoroborate,
di(4-chlorophenyl)iodonium hexafluorophosphate,
dinaphthyliodonium tetrafluoroborate,
di(4-trifluoromethylphenyl)iodonium tetrafluoroborate,
diphenyliodonium hexafluorophosphate,
di(4-methylphenyl)iodonium hexafluorophosphate, diphenyliodonium hexafluoroarsenate,
di(4-phenoxyphenyl)iodonium tetrafluoroborate,
phenyl-2-thienyliodonium hexafluorophosphate,
3,5-dimethylpyrazolyl-4-phenyliodonium hexafluorophosphate,
diphenyliodonium hexafluoroantimonate,
2,2′-diphenyliodonium tetrafluoroborate,
di(2,4-dichlorophenyl)iodonium hexafluorophosphate,
di(4-bromophenyl)iodonium hexafluorophosphate,
di(4-methoxyphenyl)iodonium hexafluorophosphate,
di(3-carboxyphenyl)iodonium hexafluorophosphate,
di(3-methoxycarbonylphenyl)iodonium hexafluorophosphate,
di(3-methoxysulfonylphenyl)iodonium hexafluorophosphate,
di(4-acetamidophenyl)iodonium hexafluorophosphate,
di(2-benzothienyl)iodonium hexafluorophosphate,
diaryliodonium tristrifluoromethylsulfonylmethide such as
diphenyliodonium hexafluoroantimonate,
diaryliodonium tetrakis(pentafluorophenyl)borate such as
diphenyliodonium tetrakis(pentafluorophenyl)borate,
(4-n-disiloxyphenyl)phenyliodonium hexafluoroantimonate,
[4-(2-hydroxy-n-tetradesiloxy)phenyl]phenyliodonium hexafluoroantimonate,
[4-(2-hydroxy-n-tetradesiloxy)phenyl]phenyliodonium trifluorosulfonate,
[4-(2-hydroxy-n-tetradesiloxy)phenyl]phenyliodonium hexafluorophosphate,
[4-(2-hydroxy-n-tetradesiloxy)phenyl]phenyliodonium tetrakis(pentafluorophenyl)borate,
bis(4-tert-butylphenyl)iodonium hexafluoroantimonate,
bis(4-tert-butylphenyl)iodonium hexafluorophosphate,
bis(4-tert-butylphenyl)iodonium trifluorosulfonate,
bis(4-tert-butylphenyl)iodonium tetrafluoroborate,
bis(dodecylphenyl)iodonium hexafluoroantimonate,
bis(dodecylphenyl)iodonium tetrafluoroborate,
bis(dodecylphenyl)iodonium hexafluorophosphate,
bis(dodecylphenyl)iodonium trifluoromethylsulfonate,
di(dodecylphenyl)iodonium hexafluoroantimonate,
di(dodecylphenyl)iodonium triflate,
diphenyliodonium bisulfate,
4,4′-dichlorodiphenyliodonium bisulfate,
4,4′-dibromodiphenyliodonium bisulfate,
3,3′-dinitrodiphenyliodonium bisulfate,
4,4′-dimethyldiphenyliodonium bisulfate,
4,4′-bissuccinimidodiphenyliodonium bisulfate,
3-nitrodiphenyliodonium bisulfate,
4,4′-dimethoxydiphenyliodonium bisulfate,
bis(dodecylphenyl)iodonium tetrakis(pentafluorophenyl)borate,
(4-octyloxyphenyl)phenyliodonium tetrakis(3,5-bistrifluoromethylphenyl)borate and
(tolylcumyl)iodonium tetrakis(pentafluorophenyl)borate,
and
ferrocenium salts (see, for example, EP 542 716 B1) such as
η5-(2,4-cyclopentadien-1-yl)[(1,2,3,4,5,6,9)(1-methylethyl)benzene]iron.

Examples of commercialized photoinitiators are Cyracure UVI-6990, Cyracure UVI-6992, Cyracure UVI-6974 and Cyracure UVI-6976 from Union Carbide, Optomer SP-55, Optomer SP-150, Optomer SP-151, Optomer SP-170 and Optomer SP-172 from Adeka, San-Aid SI-45L, San-Aid SI-60L, San-Aid SI-80L, San-Aid SI-100L, San-Aid SI-110L, San-Aid SI-150L and San-Aid SI-180L from Sanshin Chemical, SarCat CD-1010, SarCat CD-1011 and SarCat CD-1012 from Sartomer, Degacure K185 from Degussa, Rhodorsil Photoinitiator 2074 from Rhodia, CI-2481, CI-2624, CI-2639, CI-2064, CI-2734, CI-2855, CI-2823 and CI-2758 from Nippon Soda, Omnicat 320, Omnicat 430, Omnicat 432, Omnicat 440, Omnicat 445, Omnicat 550, Omnicat 550 BL and Omnicat 650 from IGM Resins, Daicat II from Daicel, UVAC 1591 from Daicel-Cytec, FFC 509 from 3M, BBI-102, BBI-103, BBI-105, BBI-106, BBI-109, BBI-110, BBI-201, BBI-301, BI-105, DPI-105, DPI-106, DPI-109, DPI-201, DTS-102, DTS-103, DTS-105, NDS-103, NDS-105, NDS-155, NDS-159, NDS-165, TPS-102, TPS-103, TPS-105, TPS-106, TPS-109, TPS-1000, MDS-103, MDS-105, MDS-109, MDS-205, MPI-103, MPI-105, MPI-106, MPI-109, DS-100, DS-101, MBZ-101, MBZ-201, MBZ-301, NAI-100, NAI-101, NAI-105, NAI-106, NAI-109, NAI-1002, NAI-1003, NAI-1004, NB-101, NB-201, NDI-101, NDI-105, NDI-106, NDI-109, PAI-01, PAI-101, PAI-106, PAI-1001, PI-105, PI-106, PI-109, PYR-100, SI-101, SI-105, SI-106 and SI-109 from Midori Kagaku, Kayacure PCI-204, Kayacure PCI-205, Kayacure PCI-615, Kayacure PCI-625, Kayarad 220 and Kayarad 620, PCI-061T, PCI-062T, PCI-020T, PCI-022T from Nippon Kayaku, TS-01 and TS-91 from Sanwa Chemical, Deuteron UV 1240 from Deuteron, Tego Photocompound 1465N from Evonik, UV 9380 C-D1 from GE Bayer Silicones, FX 512 from Cytec, Silicolease UV Cata 211 from Bluestar Silicones and Irgacure 250, Irgacure 261, Irgacure 270, Irgacure PAG 103, Irgacure PAG 121, Irgacure PAG 203, Irgacure PAG 290, Irgacure CGI 725, Irgacure CGI 1380, Irgacure CGI 1907 and Irgacure GSID 26-1 from BASF.

The skilled person is aware of further systems which can likewise be employed in the invention. Photoinitiators are used uncombined or as a combination of two or more photoinitiators.

Advantageous photoinitiators are those which exhibit absorption at less than 350 nm and advantageously at greater than 250 nm. Initiators which absorb at above 350 nm, in the violet light range, for example, are likewise employable. Sulfonium-based photoinitiators are used with particular preference, on account of their advantageous UV absorption characteristics.

It is possible, furthermore, to use photosensitizers which in a redox process reduce the photoinitiator. In this process the photoinitiator itself is decomposed, forming reactive cations which are able to initiate a cationic polymerization. This mode of reaction regime allows the cationic polymerization to be initiated at relatively high wavelengths. Examples of such photosensitizers are diphenolmethanone and derivatives, acetophenone derivatives such as, for example, Irgacure 651, anthracene derivatives such as 2-ethyl-9,10-dimethoxyanthracene and 9-hydroxymethylanthracene, phenylketone derivatives such as 1-hydroxycyclohexyl phenyl ketone, 2-hydroxy-2-methyl-1-phenylpropan-1-one and 4-(2-hydroxyethoxy)phenyl 2-hydroxy-2-methylpropyl ketone (Irgacure 184, Darocur 1173, Irgacure 2959) and also thioxanthenone derivatives such as 4-isopropyl-9-thioxanthenone or 1-chloro-4-propoxythioxanthenone.

Particularly preferred combinations of photoinitiator and sensitizer take account of the different redox potentials and retardation potentials of intermediates, as is the case for combinations of diaryliodonium based photoinitiators with acetophenone sensitizers and is described in Bulut U., Crivello J. V., J. Polym. Sci. 2005, 43, pages 3205 to 3220.

The adhesive tape of the invention comprises matrix polymer which incorporates the curable composition comprising at least one epoxy resin and also at least one curing reagent for the epoxy resin. Adhesive tapes of this kind therefore comprise an adhesive film which fundamentally is formed of a matrix polymer having embedded within it the curable composition which serves in particular as a reactive adhesive. The matrix polymer here forms a self-supporting, three-dimensional film (where the spatial extent of the film in the thickness direction is generally very much smaller than the spatial extents in the longitudinal and transverse directions, in other words than in the two directions in space of the areal extent of the film; regarding the meaning of the term “film”, see also later on below in this regard). In this matrix polymer, the curable composition, especially the reactive adhesive, has a preferably substantially uniform (homogeneous) spatial distribution, in particular in such a way that the reactive adhesive—which without the matrix might not be self-supporting—occupies essentially the same (macroscopic) distribution in space in the adhesive film of the invention as does the matrix polymer.

The function of the matrix polymer is to form an inert scaffold for the reactive monomers and/or reactive resins, so that the latter are incorporated in a film or a sheet. Accordingly it is also possible for systems which are otherwise liquid to be offered in film form. This ensures greater ease of handling. The parent polymers of the matrix are capable of forming a self-supporting film through sufficient interactions of the macromolecules with one another, for example—without wishing to impose any unnecessary restriction on the concept of the invention—by formation of a network on the basis of physical and/or chemical crosslinking.

Inert in this context means that the reactive monomers and/or reactive resins, under appropriately selected conditions (e.g. at sufficiently low temperatures), exhibit substantially no reaction with the polymeric film-former matrix.

Suitable film-former matrices used in the present invention are preferably a thermoplastic homopolymer or a thermoplastic copolymer, or a blend of thermoplastic homopolymers or of thermoplastic copolymers or of one or more thermoplastic homopolymers with one or more thermoplastic copolymers. One preferred procedure makes use, entirely or in part, of semicrystalline thermoplastic polymers.

As thermoplastic polymers it is possible in principle to select, for example, polyesters, copolyesters, polyamides, poly(ethylene-co-vinyl acetate), copolyamides, polyacrylic esters, acrylic ester copolymers, polymethacrylic esters, methacrylic ester copolymers, thermoplastic polyurethanes, and also chemically or physically crosslinked substances of the aforementioned compounds. The stated polymers may each be used as a single polymer or as a component of a blend.

According to one preferred embodiment, the polymers comprise copolymer units. Particularly preferred among the styrene copolymers are styrene rubber block copolymers such as styrene-butadiene-styrene block copolymers, styrene-isoprene-styrene block copolymers and also styrene-ethylene/butylene-styrene block copolymers (SEBS) and styrene-ethylene/propylene-styrene block copolymers (SEPS). Particularly preferred among the acrylates and methacrylates are acrylate and/or methacrylate copolymers, examples being methacrylate and/or acrylate copolymers containing glycidyl acrylate. Preferred ethylene-vinyl acetate copolymers possess a vinyl acetate fraction of between 40% and 90%, such as 50% to 70%. Suitable ethylene-vinyl acetate copolymers preferably have a Mooney viscosity (ML (1+4)/100° C.) of between 15 and 45, preferably between 20 and 30. They are available, for example, under the tradename Levapren® from Lanxess. Particularly preferred for use is Levapren® having a vinyl acetate fraction of about 60 wt % and a Mooney viscosity (ML (1+4)/100° C.) of 27±4. Preferred styrene copolymers have a styrene content of between 15 wt % and 50 wt %, preferably 25 wt % to 40 wt %. Suitable styrene copolymers preferably have a Brookfield viscosity (10% w) of 250 to 2500. Particularly preferred among the styrene copolymers are SEBS block copolymers. One such copolymer is available, for example, under the tradename Kraton® G1651, with a styrene content of about 30% and a Brookfield viscosity (10% w) of 1800. The stated polymers may be used in each case as a single polymer or as a component of a blend.

The adhesive after curing may be elastic, to ensure permanent jacketing insensitive to vibrations and twisting.

Another advantageous embodiment uses as curable adhesive a thermally curable, meltable adhesive comprising an epoxy-functionalized acrylonitrile/butadiene copolymer with on average more than 1.5 epoxide groups per molecule and the ground reaction product of phthalic anhydride and diethylenetriamine as is described in DE 10 2019 211 178 A1.

The adhesive preferably has a peel adhesion to steel by the stated measurement method of 1.5 N/cm to 25 N/cm. The unwind force by the stated measurement method of the adhesive tape of the invention is preferably in the range from 1.0 N/cm to 12 N/cm.

The total thickness of the applied adhesive is advantageously between 20 μm and 500 μm, more advantageously between 30 μm and 250 μm, very advantageously between 40 μm and 100 μm.

The coat weight of the adhesive is preferably between 40 g/m² and 500 g/m².

As carriers it is possible to use all known sheets and textile carriers such as drawn-loop knits, laid scrims, tapes, braids, needle pile textiles, felts, wovens (comprising plain, twill and satin weaves), formed-loop knits (comprising warp-knitted fabric and knitwear fabric) or nonwovens, where “nonwoven” is to be understood as meaning at least textile sheetlike structures according to EN 29092 (1988) and also stitchbonded webs and similar systems. Particularly advantageous is an adhesive tape in which the carrier used is a woven, a nonwoven or a formed-loop knit. Carriers of these kinds are described for example in WO 2015/004190 A1, hereby referenced in its entirety.

The stitchbonded fabrics also include thread course stitchbonded fabrics, these being textile sheetlike structures having one or more thread courses laid over one another as base material, which are consolidated by looping of incorporated knitting threads, with Florofol as an example; pile thread stitchbonded fabrics, these being textile sheetlike structures in which knitting threads are incorporated in pile form into a base material by means of looping, with Malipol being an example; and weft pile stitchbonded fabrics, these being textile sheetlike structures in which unlooped threads in pile form are attached by knitting threads by means of looping to a base material, with Schusspol being one example.

Also preferred, furthermore, are knit-bonded nonwovens, these being textile sheetlike structures produced without using threads, by formation of fibre loops from primary fibre nonwoven. They include fibre-based knit-bonded nonwovens, these being textile sheetlike structures composed of fibre nonwoven with a consolidating fibre loop side and a side having fibres arranged horizontally to the fibre loop layer, where fibres from the fibre nonwoven are formed into fibre loops, with Malivlies as an example; pile fibre-based knit-bonded nonwovens, these being textile sheetlike structures composed of fibre nonwoven with or without use of a base material, which consist of a fibre loop side and also a pile fibre side with fibres arranged almost perpendicular to the fibre loop layer, with Voltex, Kunit or Maliknit as examples; and loop-based knit-bonded nonwovens, these being textile sheetlike structures composed of a pile fibre-based knit-bonded nonwoven in which a second fibre loop layer has been formed from the pile fibres, with Multiknit or Optiknit as examples.

The above definitions are taken from DIN 61211:2005-05.

It is likewise possible to use woven and knitted spacer fabrics with lamination. Woven spacer fabrics of this kind are disclosed in EP 0 071 212 B1. Woven spacer fabrics are mat-shaped layered elements with a top layer comprising a fibre or filament web, a bottom layer and, between these layers, individual or bushels of holding fibres needled through the particle layer in a distributed form across the area of the layered element, and the top and bottom layers joined to one another.

Particularly suitable nonwoven fabrics are consolidated staple fibre webs, but also filament webs, meltblown webs and spunbonded webs, which usually require additional consolidation. Possible methods of consolidation known for webs are mechanical, thermal and chemical consolidation. Having proven to be particularly advantageous are webs consolidated in particular by overstitching with separate threads or by interlooping. Consolidated webs of these kinds are produced for example on stitchbonding machines of the “Malimo” type from Karl Mayer, formerly Malimo, and can be purchased from companies including Hoftex Group AG.

The carrier used may additionally be a Kunit or Multiknit web. A Kunit web is characterized in that it originates from the processing of a longitudinally oriented fibre web to form a sheetlike structure which has loops on one side and, on the other side, loop feet or pile fibre folds, but possesses neither threads nor prefabricated sheetlike structures. A nonwoven web of this kind as well has already been produced for some considerable time on stitchbonding machines of the “Malimo” type from Karl Mayer, for example. Such nonwoven stitchbonded fabrics are known under the name “Maliwatt”.

A Multiknit web is characterized relative to the Kunit web in that the web experiences consolidation on both the top and bottom sides by virtue of the double-sided needle punching. Serving in general as a starting product for a Multiknit are one or two single-sidedly interlooped pile fibre-based knit-bonded nonwovens produced by the Kunit process. In the end product, the two facing sides of the fabric are shaped by fibre interlooping to form a closed surface, and are joined to one another by fibres which stand almost perpendicular. It is possible additionally to incorporate further punchable sheetlike structures and/or scatterable media.

Also suitable, lastly, are stitchbonded nonwovens as a precursor to the formation of a carrier of the invention and an adhesive tape of the invention. A stitchbonded nonwoven is formed from a nonwoven web material having a large number of mutually parallel seams. These seams are formed by the stitched or knitted incorporation of continuous textile threads. For this type of nonwoven web, stitchbonding machines of the “Malimo” type from Karl Mayer are known.

Also particularly suitable are needle felt webs. In a needle felt, a fibre web is converted into a sheetlike structure by means of barbed needles. The needles are alternatingly punched into and pulled out of the material in order to consolidate it on a needle beam, with the individual fibres becoming entangled to form a firm sheetlike structure.

Additionally particularly advantageous is a staple fibre web, which in a first step is preconsolidated by mechanical working or which is a wet-laid web laid hydrodynamically, where between 2 wt % and 50 wt % of the fibres of the web are fusible fibres, more particularly between 5 wt % and 40 wt % of the fibres in the web. A nonwoven web of this kind is characterized in that the fibres are laid wet or, for example, a staple fibre web is preconsolidated by the formation of loops from fibres of the web, by needling, stitching, air and/or water jet processing. A second step is that of heat setting, where the strength of the web is further increased by the complete or partial melting of the fusible fibres.

Advantageously and at least regionally, the carrier has a single-sidedly or double-sidedly polished surface, preferably in each case a fully polished surface. The polished surface may be chintzed, as explained in EP 1 448 744 A1, for example. This enhances the dirt repellency.

Starting materials intended for the carrier are in particular (manmade) fibres (staple fibre or continuous filament) made from synthetic polymers, also called synthetic fibres, of polyester such as polyethylene terephthalate, polyamide, polyimide, aramid, polyolefin, polyacrylonitrile or glass, (manmade) fibres formed from natural polymers such as cellulosic fibres (viscose, Modal, lyocell, cupro, acetate, triacetate, cellulon), such as rubber fibres, such as plant protein fibres and/or such as animal protein fibres and/or natural fibres of cotton, sisal, flax, silk, hemp, linen, coconut or wool. The present invention, however, is not confined to the materials stated; instead, recognizably for the skilled person with no inventive step required, it is possible to use a large number of further fibres to produce the nonwoven web.

Likewise suitable, furthermore, are yarns fabricated from the raw materials stated. In the case of woven fabrics or laid scrims, individual threads may be produced from a blended yarn, and thus may have synthetic and natural constituents. Generally speaking, however, the warp threads and the weft threads are each formed of a pure variety of yarn.

Polyester is used with preference as a material for the carrier, owing to the outstanding ageing resistance and the outstanding media resistance with respect to chemicals and service fluids such as oil, petrol, antifreeze and the like. A further advantage of polyester is that of leading to a highly abrasion-resistant and temperature-stable carrier, this being particularly important for the specific end use for the bundling of cables in motor vehicles and, for example, in the engine compartment.

The basis weight of the carrier is advantageously between 30 g/m² and 300 g/m², more advantageously between 50 g/m² and 200 g/m², particularly advantageously between 50 g/m² and 150 g/m², very advantageously between 70 g/m² and 130 g/m².

According to one particularly advantageous embodiment of the invention, carriers used comprise a woven or nonwoven fabric made of polyester, and have a basis weight of between 50 g/m² and 150 g/m².

The carrier is preferably a carrier assembly composed of a textile carrier and a film, more particularly of a nonwoven and of a film. Particularly preferred film materials here are polyolefins, more particularly polypropylene and polyethylene. The adhesive is generally applied to the textile carrier. The adhesive penetrates this textile carrier and impregnates it. The film layer, on the side facing away from the adhesive, acts as a barrier layer and ensures that the adhesive remains on one side of the carrier.

An adhesive tape of the invention is produced preferably as described below:

A carrier assembly of textile fabric, preferably nonwoven, and polyolefinic film is coated by Mayer bar coating on the polyolefinic film layer with a carbamate solution (for example 0.5 wt % carbamate in toluene) to give a carbamate add-on of around 0.05 g/m². The coated carrier is dried for a few minutes in a drying tunnel or air circulation oven with temperatures between 80 and 110° C. and at the end is wound up.

The carbamate-coated carrier can be coated subsequently with a solvent-based or hotmelt adhesive.

For coating with a solvent-based adhesive, according to one preferred embodiment, the composition is generally as follows:

| | |
|---|---|
| 15 to 50 wt % | matrix |
| 49.9 to 82 wt % | epoxy resin |
| 0.1 to 3 wt % | photoinitiator |

The matrix may have various bases, provided that epoxy functions are present.

The adhesive is knife-coated on the nonwoven side of the carrier assembly with a weight per unit area of between 40 g/m² and 500 g/m², for example a weight per unit area of 250 g/m², and is dried in a drying tunnel at temperatures between 80 and 110° C. At the end of the drying tunnel the coated material is wound up.

The fully coated material is slit preferably into a width of 20±2 mm (any other width is likewise conceivable) and, in use for the wrapping of elongated items, is wound spirally with an overlap of 50% around the elongated item—such as a cable bundle.

The fully coated material may be lined with a liner.

Another subject of the present invention is a method for jacketing elongated items such as more particularly leads or cable sets, where an adhesive tape as described above is guided in a helical line around the elongated item or the elongated item is wrapped in an axial direction by the adhesive tape, the elongated item together with the adhesive tape wrapping is brought into the desired disposition, more particularly into the cable set plan, the elongated item is held in this disposition, and the curable adhesive is brought to cure by the supply of heat, for example by a hot air oven or hot air blower, and also the release effect of the carbamate layer is deactivated. It is also possible for the curable adhesive to be activated by another route, for example by irradiation, in particular with UV radiation. To deactivate the release effect of the carbamate layer in that case additionally the introduction of heat energy is necessary.

In an alternative method for jacketing elongated items such as more particularly leads or cable sets using the adhesive tape of the invention, the curable adhesive is first activated. The adhesive tape is immediately thereafter guided in a helical line around the elongated item or the elongated item is wrapped in an axial direction by the adhesive tape, the elongated item together with the adhesive tape wrapping is then brought into the desired disposition, more particularly into the cable set plan, and is held in this disposition while the curable adhesive cures. The release effect is then, subsequently, deactivated, as this can only take place when the adhesive tape is applied at its ultimate position. The operations of curing the adhesive and deactivating the release effect take place preferably in one step, in order to be able to observe a minimal cycle time for the user.

The adhesive tape in the first alternative is guided in a helical movement around the elongated item. This produces the form of a helix (also called screw, screw line, cylindrical spiral or coil; a helix is a curve which winds with constant gradient around the outside of a cylinder).

The tape is preferably wrapped around the elongated item spirally with an overlap of 30% to 70%, more preferably 40 to 50%, more particularly about 50%.

In the second alternative the elongated item is enveloped in an axial direction by the adhesive tape. The wrapping of a cable loom with the adhesive tape described in this case does not take place—as usually—in the form of a helical line, but instead takes place such that, during wrapping, a longitudinal axis of the tape is aligned substantially parallel to the running direction of the cable loom. As viewed in cross section, the adhesive tape in this case lies in the form of an Archimedean spiral around the cable loom. This type of wrapping is also called “cable loom bandaging” (also known to those in the art as “cigar wrapping”).

The present invention, lastly, also relates to a cable harness jacketed with the cured adhesive tape of the invention, and to a cable harness produced by the method of the invention.

According to one embodiment of the invention, the elongated item is a cable harness which comprises a bundle of multiple cables, such as 3 to 1000 cables, preferably 10 to 500 cables, more particularly between 50 and 300 cables.

### BRIEF DESCRIPTION OF THE DRAWINGS

The intention of the text below is to illustrate the adhesive tape with reference to a number of figures, without wishing thereby to impose any kind of restriction at all.

In the figures

FIG. 1 shows the adhesive tape in a lateral section,

FIG. 2 shows a detail of a cable loom which is composed of a bundle of individual cables and is jacketed with the adhesive tape of the invention, and

FIG. 3 shows one advantageous application of the adhesive tape.

Shown in FIG. 1, in a section in the transverse direction (cross section), is the adhesive tape, consisting of a fabric carrier 1, one side of which bears an applied layer of a self-adhesive coating 2 based on an acrylate dispersion.

The adhesive has been absorbed to an extent of 20% into the carrier, thus resulting in optimum anchoring and at the same time improving the hand tearability of the carrier.

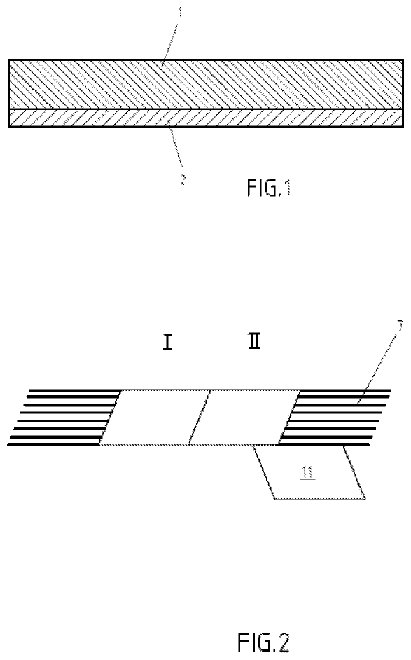

FIG. 2 shows a detail of a cable loom which is composed of a bundle of individual cables 7 and is jacketed with the adhesive tape 11 of the invention. The adhesive tape is guided in a helicoidal movement around the cable loom.

The detail of the cable loom shown has two turns I and II of the adhesive tape. Further turns would extend towards the left, but are not shown here.

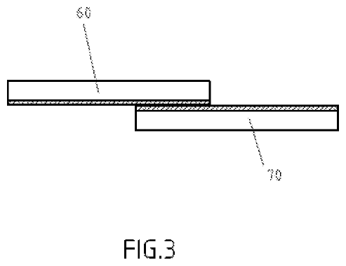

In a further embodiment for jacketing, two tapes 60 and 70 of the invention, furnished with an adhesive, are laminated with their adhesives at an offset (preferably by 50% in each case) to one another, producing a product as shown in FIG. 3.

### EXAMPLES

### Measurement Methods:

### Determination of Unwind Force

The rolls of adhesive tape are secured on an unwinding apparatus and are taken off with a speed of 30 m/min. A measurement is made of the force required to achieve this. The mean value from all measurement points is referred to the adhesive tape width and reported in N/cm.

### Determination of Peel Adhesion

For measurement of the peel adhesion forces, test strips 19 mm wide are adhered without bubbles to a finely sanded (emery paper with FEPA grit size 240) plate of stainless steel and pressed down with a rubber-clad 2 kg roller at a speed of 10 m/min. The steel plate and the protruding end of the adhesive tape are then clamped into the ends of a tensile testing machine in such a way as to produce a peel angle of 180°. The adhesive tape is peeled from the steel plate at a speed of 300 mm/min. The peel adhesion is reported in N/cm.

### Bending Test for Ascertaining Stiffness (3-Point Flexural Strength)

A test specimen consisting of 250 individual leads with a lead cross section of 0.35 mm 2 is bundled using an adhesive tape 9 mm wide (tesa 51618) to form a specimen lead set, with the specimen lead set thus having a diameter of 23±5 mm and a length of 300±50 mm. This specimen lead set is wrapped helicoidally with the stiffening material, ensuring an overlap of 50%. The stiffening material is subsequently treated by the corresponding curing method—in this case heat.

The cured specimen lead set is subjected to a bending test in order to determine the influence of the stiffening material on the stiffness. The bending test is performed on a tensile testing machine. For this test the specimen lead set is placed onto two jaws with a spacing of 70 mm and is pressed in centrally with a crosshead by a distance of 30 mm, and subjected to load. The force required for the deformation of the measurement travel is recorded by a tensile testing machine in newtons. The testing speed is 100 mm/min, both during loading and during unloading of the specimen lead set. The test is carried out at three different points on the lead set (start, middle and end). The bending force results from the mean value of the three individual measurements, and is evaluated in three categories as follows:

### Evaluation Categories for 3-Point Bending Trial:

+ highly suitable for the application
   (>20 to 100 N)
◯ of limited suitability for the application
   (10 to 20 N and >100 to 150 N)
− not suitable for the application
   (<10 and >150 N)

### Example—Production of an Adhesive Tape

A carrier assembly consisting of nonwoven and polyolefinic film (RKW type 21002 with 36 g/m² nonwoven and 30 g/m² polypropylene) was coated by means of Mayer bar coating on the polyolefinic film layer with a carbamate solution (0.5 wt % carbamate, Release KB 100 from Ichemco srl, Cuggiono, Italy), to give a carbamate add-on of around 0.05 g/m² (wet film add-on of around 6 μm). The coated carrier was dried in a drying tunnel at 110° C. for two minutes, resulting in a coat weight of 30 mg/m², and at the end was wound up.

The carbamate-coated carrier was subsequently coated with a solvent-based adhesive. The composition of the solvent-based adhesive was as follows:

| Raw material | Chemical characterization |
|---|---|
| Levamelt 700 | Ethylene-vinyl acetate copolymer with 70 wt % vinyl |
| | acetate |
| Araldite | Unmodified epoxy resin based on bisphenol A with |
| GT 7072 | narrow molecular weight distribution |
| Araldite | Unmodified epoxy resin based on bisphenol A with |
| GY 250 | medium viscosity |
| Polycavit 3662 | Elastomer-modified epoxy resin |
| Irgacure 651 | 2,2-Dimethoxy-1,2-diphenylethan-1-one |
| Deuteron 1242 | Compound based on bis(dodecylphenyl)iodonium |
| | hexafluoroantimonate |
| | Present in solution with the reactive diluent C12/C14 |
| | glycidyl ether; solids content 50% |

For the production of the adhesive of the example, 19.4 parts by weight of Levamelt 700 (Arlanxeo), 49.9 parts by weight of Araldite GT7072 (Huntsman), 20.3 parts by weight of Araldite GY250 (Huntsman), 7.5 parts by weight of Polycavit 3662 (Struktol) (epoxy resin), 1 part by weight of Irgacure 651 and 1.9 parts by weight of Deuteron 1242 are weighed out and blended with butanone so as to give a solids content of 60%.

The adhesive is knife-coated on the nonwoven side of the carrier assembly and is dried in a drying tunnel at temperatures between 80 and 110° C. to give a weight per unit area of 250 g/m². The coated material at the end of the drying tunnel is wound up.

The adhesive tape is subjected to the 3-point flexural strength test. Before being cured it was exposed to temperature for 5 minutes in each case with the temperatures specified in the following table:

| Temperature exposure | 23° C. | 80° C. | 110° | 140° C. |
|---|---|---|---|---|
| 3-point flexural strength [N] | 20 | 28 | 30 | 39 |

There is a clear dependency apparent between the strength and the temperature. The 3-point flexural strength increases as the temperature goes up when the release layer has been deactivated by effect of temperature. The higher the temperature, the more effectively the release layer could be deactivated, leading in turn to an increase in the adhesion, which is manifested in the improved flexural strength.

1. An adhesive tape for jacketing elongated items, comprising a tapelike carrier provided on at least one side with a curable adhesive, wherein the adhesive tape is further provided on one side of the tapelike carrier with a release layer of carbamate.

2. Adhesive tape according to claim 1, wherein the adhesive tape is provided on one side of the tapelike carrier with a curable adhesive and on the other side with the release layer of carbamate.

3. Adhesive tape according to claim 1, wherein the carrier layer comprises a woven textile fabric or a nonwoven fabric and a film.

4. Adhesive tape according to claim 1, wherein the curable adhesive is activated by means of radiation energy, thermal energy, moisture or pressure.

5. Adhesive tape according to claim 1, wherein the release effect of the carbamate is temperature-reversible.

6. Adhesive tape according to claim 1, wherein the carbamate is a salt or ester of carbamic acid.

7. Adhesive tape according to claim 1, wherein the tapelike carrier is a textile carrier and the textile carrier has a basis weight between 30 g/m² and 300 g/m².

8. Adhesive tape according to claim 1, wherein the curable adhesive has a coat weight between 40 g/m² and 500 g/m².

9. A method for jacketing an elongated item, said method comprising guiding an adhesive tape according to claim 1 in a helical line around the elongated item or wrapping the elongated item in an axial direction by the adhesive tape, bringing the elongated item together with the adhesive tape into a desired disposition, holding the elongated item together with the adhesive tape in this disposition, and curing the curable adhesive and also deactivating a release effect of the carbamate layer.

10. A method for jacketing elongated items, comprising first activating an adhesive tape according to claim 1 and immediately thereafter guiding the adhesive tape in a helical line around the elongated item or wrapping the elongated item in an axial direction with the adhesive tape, bringing the elongated item together with the adhesive tape into a desired disposition, and holding the elongated item together with the adhesive tape in this disposition while the curable adhesive cures.

11. A cable harness wrapped with an adhesive tape according to claim 1.
